(19) United States
(12) Patent Application Publication
(10) Pub. No.: US 2005/0085267 A1
(43) Pub. Date: Apr. 21, 2005

(54) Modular base station antenna control system

(76) Inventors: Paul Lemson, Woodinville, WA (US); Gideon Argaman, Kiryat Tivon (IL); Joseph Shapira, Haifa (IL); Shmuel Miller, Oshrat (IL)

Correspondence Address: Martin Moynihan;Anthony Castorina, 2001 Jefferson Davis Highway, Suite 207, Arlington, VA, 22202, US

(21) Appl. No.: 10/498,506

(22) PCT Filed: Dec. 23, 2002
(86) PCT No.: PCT/US02/38980

Related U.S. Application Data
(60) Provisional application No. 60/342,105, filed on Dec. 26, 2001.

(51) Int. Cl. H04M 1/00

(52) U.S. Cl. 455/562.1; 455/561

(57) ABSTRACT

A modular base station enhancing system includes multiple bi-directional amplifiers that are remotely controlled. Duplexers, corresponding to the bi-directional amplifiers, interface the bi-directional amplifiers with base station antenna elements, enabling simultaneous transmission and reception through the antenna elements. A control circuit, located remotely from the base station and the bi-directional amplifiers, enables control of at least one parameter in each of the bi-directional amplifiers to control transmission and reception characteristics of the antennas elements. The controllable bi-directional amplifiers may include a linear power amplifier to amplify transmitted signals and a low-noise amplifier to amplify received signals. The base station enhancing system is interoperable with different types of antenna elements, and may be implemented as a radio frequency (RF) front-end of the base station or as an RF repeater.

### RELATED APPLICATIONS

This application claims the benefit of U.S. Provisional Application No. 60/342,105, filed Dec. 26, 2001, the contents of which are expressly incorporated by reference herein in its entirety.

### BACKGROUND OF THE INVENTION

1. Field of the Invention

The present invention relates to the field of cellular communications. In particular, the present invention relates to base station arrangements for diversity transmission and reception.

2. Background Information

With the dramatic expansion in wireless communications, significant efforts are being expended to improve the capabilities of cellular networks. New standards have emerged, such as, for example, second and third generation code division multiple access (CDMA), enabling efficient uniform frequency reuse, high capacity and improved performance. The benefits of the new standards, such as the afore-mentioned second and third generation CDMA, are best realized by optimizing the coverage and link balancing of the cellular network base stations.

Conventionally, each base station would need to be optimized or replaced in response to changes in wireless communications standards, as well as traffic activity environment. Increasing or significantly altering the network capacity generally requires the addition of costly infrastructure, such as base stations, which constitute about 80 percent of the network cost. For example, a typical cost of a full capacity large cell base station may be between $500,000 and $1,000,000.

New infrastructure also includes additional interconnect trunking, which, depending on the length of interconnect lines between system components (e.g., a base station and its corresponding tower top antenna) may result in signal degradation. Because of the potentially long distance between system elements, as well as the susceptibility of the wireless network to signal attenuation and interference, relatively large gauge, radio frequency (RF) interconnect lines (cable) having a diameter of 1⅝ inches, for example, are typically utilized, increasing the cost of such networks.

Current regulatory and practical constraints highlight a need for flexible, distributed base station configurations, in which the RF subsystems are positioned near the antenna. However, to the extent partially distributed base station configurations are presently available, they lack efficient controllability, modularity and reliability and are difficult to maintain.

The typical arrangements of conventional base stations, as well as equipment supporting base stations (e.g., RF and optical fiber repeaters), are not conducive to capacity upgrades. For example, a conventional base station includes an integral RF front-end for interfacing base station sectors with dedicated antennas, which are usually located a significant distance from the base station, such as, but not limited to, on top of a tower). Neither the RF front-end nor the antennas are normally interchangeable with other types of base station components.

Some conventional base stations, such as those in use with micro-cells, include a remote RF front-end system that is integral and co-located with the base station antenna. However, the front-end/antenna combination lacks flexible controllability and is subject to the drawback of being located at a distance from the base station, thereby requiring expensive interconnect lines or experiencing significant power loss or signal noise. Also, even though the front-end is located separately from the base station, it is still inherently limited to serving the type of base station and antenna combination for which it was originally designed and implemented. Thus, a network provider has little flexibility in efficiently changing the base station components.

The present invention overcomes the problems associated with the prior art, as described below.

### BRIEF DESCRIPTION OF THE DRAWINGS

The present invention is further described in the detailed description that follows, by reference to the noted drawings by way of non-limiting examples of embodiments of the present invention, in which like reference numerals drawings, and in which:

FIG. 1 is a block diagram showing an exemplary Advance RF Access (ARFA) unit for space diversity for transmitting and receiving RF signals, according to an aspect of the present invention;

FIG. 2A is a block diagram showing an exemplary ARFA unit with polarization diversity for transmitting and receiving RF signals, according to an aspect of the present invention;

FIG. 2B is a block diagram showing an exemplary ARFA unit with polarization control of transmitting and receiving RF signals, according to an aspect of the present invention;

FIG. 2C is a block diagram showing an exemplary ARFA unit with polarization control of transmitting RF signals, that utilizes the maximum power from both power amplifiers, and polarization control of receiving RF signals, according to an aspect of the present invention;

FIG. 3A is a block diagram showing an exemplary ARFA unit with space diversity for transmitting and receiving RF signals, with beam tilting, according to an aspect of the present invention;

FIG. 3B is a block diagram showing another exemplary ARFA unit with space diversity for transmitting and receiving RF signals, with beam tilting, according to an aspect of the present invention;

FIG. 4A is a block diagrams showing an exemplary ARFA unit with electronic beam squint, according to an aspect of the present invention;

FIG. 4B is a block diagrams showing another exemplary ARFA unit with electronic beam squint, according to an aspect of the present invention;

FIG. 5A is a block diagram showing an exemplary ARFA unit with a fully adaptive array antenna, according to an aspect of the present invention;

FIG. 5B is a block diagram showing an exemplary ARFA unit for with a fully adaptive array antenna having multi-column configuration, according to an aspect of the present invention;

FIG. 6 is a block diagram showing an exemplary repeater with space diversity for transmitting and receiving RF signals, according to an aspect of the present invention;

FIG. 7 is a block diagram showing an exemplary repeater with polarization diversity for transmitting and receiving RF signals, according to an aspect of the present invention;

FIG. 8 is a block diagram showing an exemplary fiber repeater with space diversity for transmitting and receiving RF signals, according to an aspect of the present invention; and

FIG. 9 is a block diagram showing an exemplary fiber repeater with polarization diversity for transmitting and receiving RF signals, according to an aspect of the present invention.

### SUMMARY OF THE INVENTION

The present invention relates generally to improving base station functionality in wireless telecommunications networks, such as, but not limited to, CDMA, CDMA2000, universal mobile telecommunications system (UMTS), global system for mobile communications (GSM) and personal communications service (PCS) networks. One aspect of the invention involves a controllable, modular front-end extension of a base station to enhance base station performance. The modular front-end shapes and/or controls the base station's downlink and uplink patterns of multi-column antenna arrays, regardless of antenna type, and includes control of signal polarization and diversity. Another aspect of the invention involves controllable, modular repeaters, including optical fiber repeaters, to enhance base station coverage.

In view of the above, the present invention through one or more of its various aspects and/or embodiments is presented to accomplish one or more objectives and advantages, such as those noted below.

An aspect of the present invention provides a modular front-end system of a base station in a wireless communications network, that is interoperable with different antenna types. The front-end system includes at least one controllable bi-directional amplifier, located remotely from the base station, and at least one duplexer that interfaces the bi-directional amplifier to an antenna, enabling simultaneous transmission and reception through the antenna. At least one parameter of the bi-directional amplifier is controlled through a control circuit in the front-end system. The control circuit may receive control signals from either the base station, via a first control interface, or a remote monitoring and control device, via a second control interface, or both. The first and second control interfaces may be serial interfaces. Also, the at least one parameter of the bi-directional amplifier may be a signal gain and/or a signal phase. The base station and/or the antenna may be part of an existing base station system. The bi-directional amplifier and the duplexer are adapted to interface with the existing base station system.

Another aspect of the present invention provides a repeater system, associated with a base station in a wireless communications network, that is interoperable with different antenna types. The repeater system includes at least one controllable bi-directional amplifier and at least one duplexer that interfaces the at least one bi-directional amplifier to an antenna, enabling simultaneous transmission and reception of RF signals through the antenna. The repeater system further includes a donor interface that enables communication with the base station. At least one parameter of the bi-directional amplifier is remotely controlled through a control circuit in a remote repeater controller. The control circuit may receive control signals from at least one of the base station, via a wireless modem and a first control interface, and a remote monitoring and control device, via a second control interface. The base station and/or the antenna may be part of an existing base station system, such that the bi-directional amplifier and the duplexer are adapted to interface with the existing base station system.

The donor interface may include a donor antenna that communicates the RF signals with the base station through a donor antenna. Alternatively, the donor interface may include a multiple fiber converters that convert between the RF signals and a wavelength compatible with transmission over a fiber optic line. A first fiber converter is located on a first end of a fiber optic line, associated with the base station. A second fiber converter is located on a second end of the fiber optic line, associated with the repeater system.

The antenna of the modular front-end may be located remotely from the at least one bi-directional amplifier. The antenna for either the modular front-end or the repeater may be a sector antenna, an omni antenna and/or a diversity antenna system. The diversity antenna system may include at least two antennas, spaced for space diversity, or a dual polarization antenna. The dual polarization antenna includes multiple beams, each of which may be electrically controlled to tilt by the control circuit. The diversity antenna system may alternatively include a multiple column array antenna.

Another aspect of the present invention provides a method for enhancing transmission and reception of signals at a base station in a wireless communications network, using a full-duplex modular radio frequency (RF) front-end, which is interoperable with different base station antenna systems. The method includes receiving a transmit signal from the base station at the modular RF front-end, splitting the transmit signal into a transmit diversity branch and a transmit main branch, and processing at least one of the transmit diversity branch and the transmit main branch in accordance with a remotely issued control signal. The processing may include amplifying the transmit diversity branch and the transmit main branch in accordance with the control signal. After processing, the transmit diversity branch and the transmit main branch are sent to a predetermined base station antenna system for transmission at a selected RF frequency. A phase of the transmit diversity branch maybe shifted with respect to the transmit main branch in accordance with the remotely issued control signal. The remotely issued control signal may be issued by a remote monitoring and control terminal through a serial interface, such as an RS-485 interface.

The method may further include receiving a receive diversity branch and a receive main branch of a received signal from the predetermined antenna system and processing at least one of the receive diversity branch and the receive main branch in accordance with a second remotely issued control signal. The processing may include amplifying the receive diversity branch and the receive main branch in accordance with the second control signal. After processing, the receive diversity branch and the receive main branch are sent to the base station for detection.

Another aspect of the present invention provides method for enhancing transmission and reception of signals at a base station in a wireless communications network, using a full-duplex modular RF repeater, which is interoperable with different antenna systems. The method includes receiving a transmit signal at the modular RF repeater from the base station through a donor communications link, splitting the transmit signal into a transmit diversity branch and a transmit main branch, and processing at least one of the transmit diversity branch and the transmit main branch in accordance with a remotely issued control signal. After processing, the transmit diversity branch and the transmit main branch are sent to a repeater antenna system for transmission. The donor communications link may be a narrow beam antenna or a fiber optic line.

The method for enhancing transmission and reception of signals at a base station may further include receiving a receive diversity branch and a receive main branch of a received signal frequency from the repeater antenna system and processing at least one of the receive diversity branch and the receive main branch in accordance with a second remotely issued control signal. After processing, the receive diversity branch and the receive main branch are sent through the donor communications link to the base station for detection.

Yet another aspect of the present invention provides a system for enhancing a base station, including multiple controllable bi-directional amplifiers, multiple duplexers, and a control circuit. Each duplexer interfaces the controllable bi-directional amplifiers with a respective one of multiple antenna elements, enabling simultaneous transmission and reception. The control circuit, located remotely from the bi-directional amplifiers, enables control of at least one parameter in each of the bi-directional amplifiers to control at least one transmission and reception characteristic. The modular system may further include at least one modem, such that the control circuit enables parameter control through the modem. The controllable bi-directional amplifiers may include at least a linear power amplifier that amplifies transmitted signals, and a low-noise amplifier that amplifies received signals. The bi-direction amplifiers and duplexers may be located in a front-end extension of the base station or a repeater associated with the base station. The modular system may interface an existing base station and/or antenna elements. The various aspects and embodiments of the present invention are described in detail below.

### DETAILED DESCRIPTION OF EMBODIMENTS

The present invention relates to an Advanced RF Access (ARFA) remote front-end unit of a base station, implemented in a wireless communications network. The ARFA unit enables coverage shaping and/or control of transmit and receive signals, such as RF downlink and uplink signals in a CDMA cellular network, and offers a low system noise figure. The ARFA unit is modular, generally including a control unit, located in close proximity to the base station, and a bi-directional amplifier (BDA), generally located in close proximity with the base station antenna and modified for full-duplex communications. The close proximity to the antenna enables the ARFA unit to support and control both coverage shaping and diversity features, enabling the use of fully adaptive array (i.e., “smart”) antennas, for example, with the salient low noise figure and multi-carrier power transmission of remote antenna and multi-diversity systems. The invention may further include an ARFA system manager, having communications, monitoring and control software that enables redundant remote monitoring and/or control of a group of ARFA units.

Because the ARFA units are modular, they may be programmed and implemented independently of the base stations and corresponding antenna elements that they support. The ARFA units therefore provide significant flexibility in configuring (or reconfiguring) base stations to enhance network coverage. Further, a network provider may implement the ARFA unit with an existing base station, repeater and antenna systems to significantly improve performance without incurring significant expenses to replace or upgrade the core (pre-existing) equipment.

The ARFA units of the present invention may be configured to support a variety of cellular network optimization requirements. For example, the ARFA units may be deployed in cellular networks consisting of multiple clusters, each with multiple cells. The ARFA units may likewise be included in micro-cells with coverage-controlled sector arrays, enabling cellular communications in urban areas, for example, where signals transmitted to and from fall sized cells would likely be blocked. The ARFA units are relatively non-complex and are therefore not only relatively inexpensive, but also generic for most antenna arrays. For example, the ARFA units may provide shaping of cellular coverage for a single cell site or sector, using fully adaptive array (i.e., “smart”) antennas, discussed below. Also, the ARFA unit may be configured to support the functionality of remote antenna and multi-diversity coverage systems, such as a BEAMER™ system, available from Celletra Ltd. discussed below.

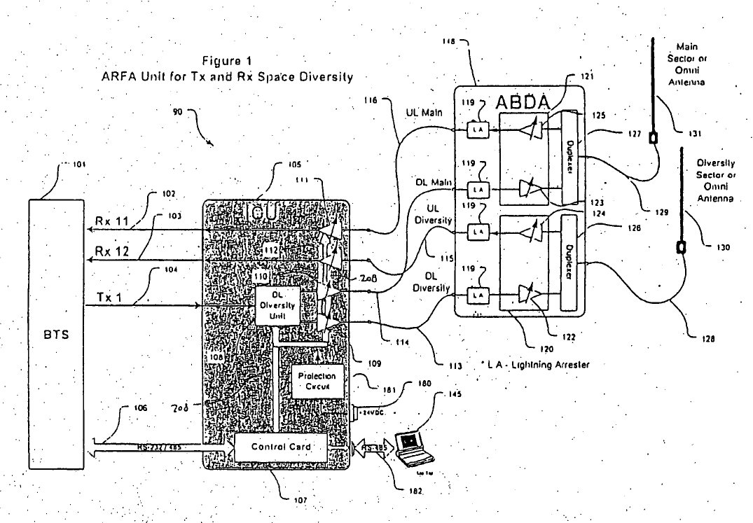

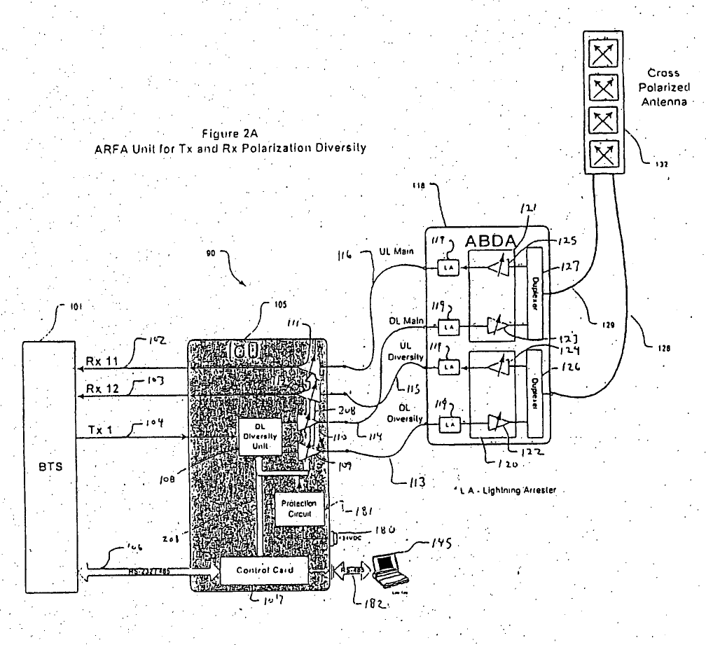

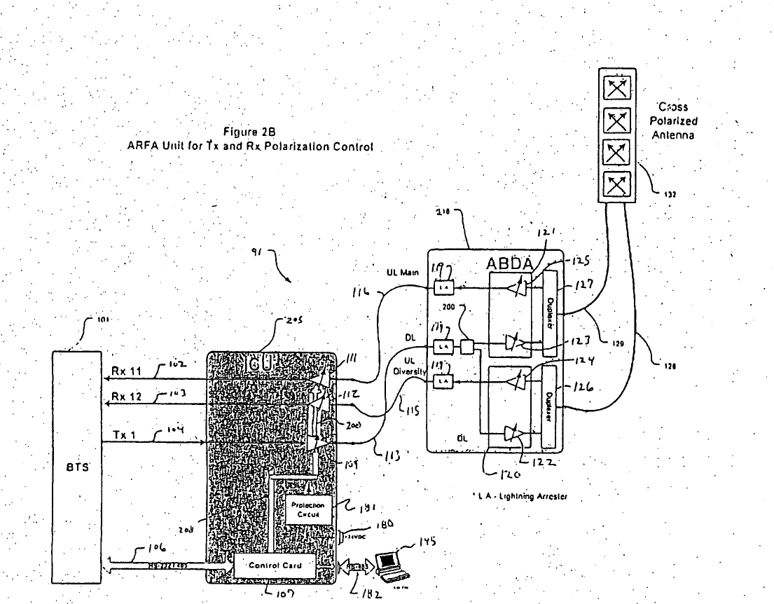

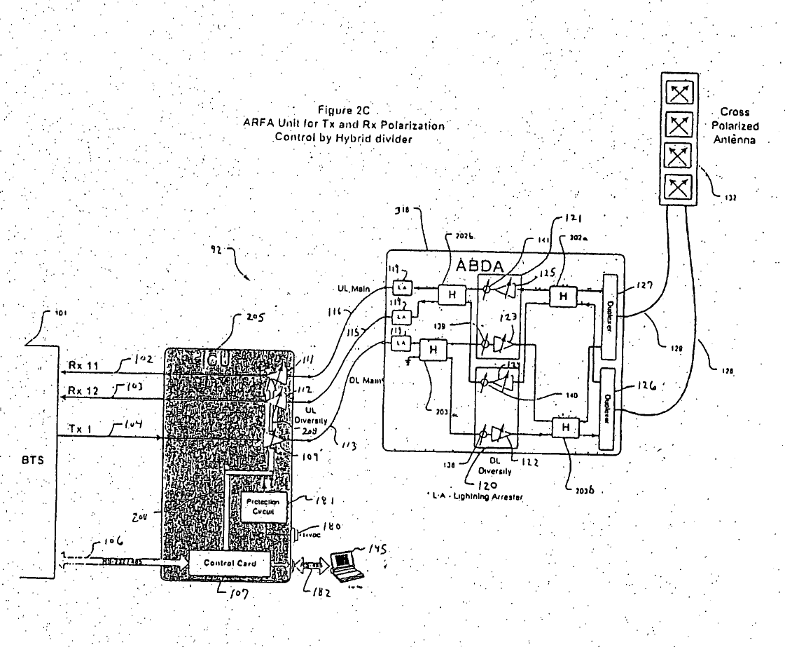

FIGS. 1 through 9 are block diagrams depicting exemplary embodiments of the present invention. Although some of the illustrated embodiments show implementation of a single ARFA unit, it is understood that multiple ARFA units may be coupled to enable independent control of coverage and other system-wide parameters. Also, elements of the various embodiments of FIGS. 1 through 9 are the same in each embodiment. Accordingly, only the differences between the various embodiments are discussed with respect to FIGS. 2-9.

In each of the depicted embodiments, the ARFA unit includes a fully controlled, bi-directional amplifier, built for outdoor operation (e.g., environmentally sealed and self-stabilizing to reduce expected variations over temperature). The amplitude and phase of the ARFA unit in each embodiment is controllable through a corresponding monitoring and control communications device, described below. As indicated, the ARFA unit is interoperable with any selection of antenna systems, such as sector antennas, omni antennas, space and phase polarization diversity antennas, steerable antennas, multiple column intelligent antennas, antenna arrays and the like. The ARFA unit therefore enables enhancement of the communications network using any pre-existing antenna, as opposed to having to acquire a new antenna, to satisfy economic considerations and market requirements of the network provider. Furthermore, because of modularity, the ARFA unit is relatively simple to install in pre-existing systems, accommodating on-the-tower “plug and play” addition and replacement.

FIGS. 1 through 5B depict exemplary ARFA units that enhance the functionality of base stations in a cellular network by providing remote RF front-end functionality. FIG. 1, in particular, depicts an ARFA unit 90 providing an RF extension of one sector of a base station, such as the base transceiver station (BTS) sector 101, with transmit and receive diversity. The ARFA unit 90 includes an interface and control unit (ICU) 105 and an advanced BDA (ABDA) 118. The ICU 05 and the ABDA 118 are calibrated and balanced to operate essentially as a matched pair. In the disclosed embodiments, the ARFA unit 90 is powered by 24 volts DC, for example, through the DC power source 180 and the corresponding protection circuit 181 in the ICU 105.

As stated above, the ICU 105 is typically located in close proximity to the base station (e.g., the BTS 101) and the ABDA 118 is typically located in close proximity to the antenna system (e.g., antennas 130 and 131). For example, the ABDA 118 may be located proximate the top of an antenna tower, while the ICU 105 is located in a base station cabinet proximate the base of the tower. The close proximity enables the use of small diameter gauge RF cables 102, 103 and 104 connect to the ICU 105 and the BTS 101. For example, the cables 102, 103 and 104 connecting the ICU 105 and the BTS 101 may be ¼ inch to ½ inch diameter cables, as opposed to conventional 1 ⅝ inch diameter cables. Likewise, the close proximity of the ABDA 118 and the antennas 130 and 131 enables the use of small diameter cables 128 and 129 to interconnect the antennas 130 and 131 to the ABDA 118. Furthermore, the cables connecting the ICU 105 and the ABDA 118 (e.g., the cables 113, 114, 115 and 116) may be the smaller diameter cables, even when the ICU 105 and the ABDA 118 are located a significant distance apart; due to the controlled amplification of the downlink and uplink signals prior to traversing the cables, as discussed below. It is noted that smaller diameter cables are less expensive and, due to their inherent light weight and flexibility, more efficient to install.

The ARFA unit 90 is controlled by a control circuit, such as a control card 107, which communicates with the BTS 101 through the control interface 106 using a compatible signaling protocol, such as, but not limited to, RS-232, RS-485, or the like. The control card 107 optionally may be controlled by a remote monitoring and control device 145, such as a laptop computer or other graphical user interface (GUI), through a control interface 182, using a compatible signaling protocol, such as, but not limited to, RS-485 or the like. As depicted in FIG. 1, the monitoring and control device 145 plugs into an RS-485 port on the ICU 105. In an alternative embodiment, the output of the RS-485 port may be communicated to another communications network, enabling the monitoring and control device 145 to be located remotely from the ICU 105. For example, the output of the RS-485 port may be passed through a modem to an Internet web server, which may be accessed by the network provider through any device capable of accessing the Internet, including a laptop computer, a personal computer, a personal digital assistant (PDA) or the like.

The BTS 101 and the monitoring and control device 145 redundantly accommodate a system manager, coupled to control card 107 of the ARFA unit 90, through the respective interfaces to monitor and control the functionality of the ARFA unit 90. The control card 107 is linked to the controlled amplifiers within the ICU 105 (e.g., amplifiers 109, 110, 111 and 112), as well as diversity units within the ICU 105 (e.g., downlink (DL) diversity unit 108), through a control bus or other circuit, indicated by control line 208. The control line 208 is indicated as two directional, and is shown by arrows between the control card 107 and the DL diversity unit 108 and between the control card 107 and the amplifier 109. The control line 208 is also shown as extending to the amplifiers 110, 111 and 112. It is understood, however, that the DL diversity unit 108 and each of the amplifiers 109, 110, 111 and 112 are connected directly to the control line 208. The control line may be uni-directional, under certain circumstances, without departing from the scope and/or spirit of the invention. The signaling between the ICU 105 and the ABDA 118 is multiplexed on one of the RF cables connecting them, such as, for example, the cable 116, and linked to the control card 107 via the control line 208.

An application software capability of the system manager monitors performance parameters of elements in the ARFA unit 90, such as the input and output power of the ICU 105 and the ABDA 118, as well as the gain and coordination of the multiple controllable amplifiers (and filters), discussed below. Furthermore, system alarms are received by the BTS 101 and the monitoring and control device 145, through the control card 107, to indicate, for example, a substandard operational condition. The application software capability also controls the balancing of power and gain in the downlink and uplink signals to maintain proper diversity and beam shaping, according to a particular application, based on the monitored parameters.

The transmit signal path of an RF signal transmitted from the BTS 101 passes through the transmit RF cable 104 to the ICU 105. At the ICU 105, the transmitted signal is split into a main branch (i.e., downlink main) and a diversity branch (i.e., downlink diversity) by a transmit diversity unit (TDU), shown as the DL diversity unit 108. As discussed above, the monitoring and control signals pass between the control card 107 and the DL diversity unit 108 and/or the amplifiers 109, 110, 111 and 112 through the control line 208.

In an embodiment f the invention, the DL diversity unit 108 inserts a time delay in the diversity branch signal, known as time delay transmit diversity (TDTD). For example, the delay may be longer than one CDMA Chip (e.g., 0.8 microsecond in the IS-95 standard). The time delay between the diversity branch signal and the main branch signal enables the CDMA receiving station (e.g., a mobile station) to receive each signal using a different correlator of its rake receiver. The receiving station is thereby able to diversity combine the two signals by adjusting the relative phases and/or amplitudes to stabilize the signal stream and to reduce fading. It is understood, however, that the DL diversity unit 108 is not limited to the use of TDTD, but that the DL diversity unit 108 (as well as uplink diversity units, discussed below) may implement any method for, creating diverse branches of a signal without departing from the scope and spirit of the invention.

The diversity branch signal and the main branch signal are respectively conditioned at amplifiers 109 and 110, which are digitally controlled preamplifiers. The amplifiers 109 and 110 may include bias-T's, which enable RF and DC signals, for example, to be applied to a single RF cable, such as cables 113 and 114. The gains of the amplifiers 109 and 110 are controlled by the control card 107 to output the proper power level required by the ABDA unit 118. The amplifiers 109 and 110 are equipped with sensors (not shown) to monitor predetermined performance parameters. The control card 107 implements the control functionality, based in part on the status of the predetermined performance parameters, through either the monitoring and control device 145 via the control interface 182, or the BTS 101 via the control interface 106.

As stated above, the amplifiers 109 and 110 may multiplex RF transmit branches with DC and/or control signals over the RF cables 113 and 114, respectively, to the ABDA 118. However, it is understood that the DC and/or control signals may be communicated between the ICU 105 and the ABDA 118 through any combination of uplink and downlink cables 113, 114, 115 and/or 116. For example, the monitoring and control signals may pass through the control line 208, between the control card 107 and the uplink controlled amplifiers 111 and 112, which may be digitally controlled preamplifiers with bias-T's. The monitoring and control signals are then multiplexed and passed to the BDAs 120 and 121 via the cables 115 and 116, respectively.

The control interface 182 includes, for example, a serial interface. While the embodiments shown herein depict the control interface 182 as an RS-485 interface, it is understood that other serial type interfaces, such as, but not limited to RS-232 universal serial bus (USB), IEEE 1394 and the like, may be utilized without departing from the scope or spirit of the invention.

Each RF transmit branch passes through an optional lightning arrestor 119, which is designed to relay DC power into a transmission input of the BDA 120 or the BDA 121 in the ABDA unit 118. The BDA 120 and the BDA 121 are environmentally sealed and fully monitored and controlled. The BDA 120 incorporates a linear power amplifier (LPA) 122 for amplifying transmitted diversity branch signals (i.e., downlink diversity) and a low-noise amplifier (LNA) 124 for amplifying received diversity branch signals (i.e., uplink diversity). Likewise, the BDA 121 incorporates an LPA 123 for amplifying transmitted main branch signals (i.e., uplink main) and an LNA 125 for amplifying received main branch signals (i.e., uplink main). The redundant amplifiers support a variety of functionality, including transmit and receive signal diversity, coverage lobing, fully adaptive arrays and the like.

Similar to the amplifiers 109 and 110 located in the ICU 105 the LPAs 122 and 123 and the LNAs 124 and 125 in the ABDA 118 are equipped with sensors (not shown) to monitor performance parameters thereof. For example, the LPAs 122 and 123 may be multi-carrier super-linear transmission amplifiers, which are remotely monitored and controlled, and sufficiently reliable and robust for tower-top operation. Likewise, the BDA 120 and 121 include “power conditioning circuits, performance sensors and control circuits (not shown) to further enable remote control of the ABDA 118. For example, the output power of the BDA 120 and the BDA 121 are controlled to equal one another by altering the respective gains of the LPAs 122 and 123. The control is provided by the control card 107, based on instructions from the monitoring and control device 145 and/or the BTS 101 (e.g., using a self calibration table). As stated above, the control signals are multiplexed onto RF signals passing between the ICU 105 and the ABDA 118, such as the uplink signals coming from the LNA 125 over the cable 116 to the input of the amplifier 111 in the ICU 105, and from the LNA 124 over the cable 115 to the input of the amplifier 112 in the ICU 105, to control the various elements of the ABDA 118. Alternatively, the ABDA 118 may include one or more modems (not shown), which enable monitoring and control communications with the control card 107 in the ICU 105 without having to multiplex the communications over the RF tables.

In an embodiment of the invention, the BDAs 120 and 121 are BEAMER™ units, available from Celletra Ltd. The BEAMER™ unit is described in detail in PCT Application Ser. No. IL98/00103, filed on Mar. 3, 1997, entitled “Cellular Communications Systems,” the disclosure of which is expressly incorporated by reference herein in its entirety. Alternatively, each of the BDAs 120 and 121 may simply include a set of tower-top bi-directional amplifiers, which do not employ BEAMER™ units. Also, in an embodiment of the invention, the BDAs 120 and 121 may be less complex, for example, having only one bi-directional amplifier instead of a pair of bi-directional amplifiers.

The ABDA 118 further includes duplexers 126 and 127, that are connected to the BDAs 120 and 121, respectively. The duplexers 126 and 127 enable the ARFA unit 90 to transmit and receive downlink and uplink RF signals on the same antenna simultaneously, through the antennas 130 and 131. The duplexer 126 provides full-duplex functionality for the transmit and receive diversity signals, while the duplexer 127 provides full-duplex functionality for the transmit and receive main signals.

The RF cables 128 and 129 connect the respective signal branches, of the duplexers 126 and 127 to the diversity antenna 130 and the main antenna 131. The antennas 130 and 131 may be omni or sector antennas, positioned to enable space diversity (e.g., typically a separation of 10 wavelengths of the transmission signal). The diversity branch signal and the main branch signal are transmitted simultaneously from the space diverse antennas 130 and 131, enabling diversity transmission of the downlink signal to the receiving station (e.g., a mobile station). The invention likewise applies to single omni or sector antennas enabling non-diversity signal communications.

The uplink signal received by each of the antenna elements 130 and 131 likewise includes a diversity branch signal and a main branch signal. The diversity branch signal is fed through the cable 128 to the duplexer 126 and the LNA 124. The main branch signal is simultaneously fed through the cable 129 to the duplexer 127 and the LNA 125. The amplified signals are relayed via the cables 115 and 116 to the ICU 105. As discussed above, the highly linear LNAs 124 and 125 operate to amplify the received signal and to compensate for the attenuation through the cables 115 and 116, reduce the system noise figure and enhance the receive diversity. Within the ICU 105, the received signal branches are amplified and equalized in controlled amplifiers 111 and 112, which again compensate for cable losses that degrade the system noise figure and preserve the sensitivity of the BTS 101. The amplified main branch signal is sent to the BTS 101 through the cable 102 and the amplified diversity branch signal is sent to the BTS 101 through the cable 103. The BTS 101 uses the space diversity of the diversity and main branch signals to efficiently detect the uplink signal.

FIG. 2A is a block diagram depicting an exemplary ARFA unit 90 providing an RF extension of the BTS 101 with transmit and receive polarization diversity. The system in FIG. 2A is the same as the system in FIG. 1, except that space diverse antennas 130 and 131 are replaced by a single cross-polarized antenna 132. Accordingly, as previously explained, only the differences between the embodiments of FIG. 1 and FIG. 2A are presented herein.

To transmit a downlink RF signal, the antenna 132 receives the diversity branch signal and the main branch signal from the ARFA unit 90 through the cables 128 and 129 respectively, which are connected to the antenna 132 to accommodate different polarizations. For example, the polarizations may be slant linear polarizations (e.g., approximately ±45 degrees). The arrangement shown in FIG. 2A likewise enables polarization diversity of the uplink signals.

FIG. 2B is a block diagram depicting an exemplary ARFA unit 91 providing an RF extension of the BTS 101 with transmit polarization control. The system in FIG. 2B is the same as the system in FIG. 2A, except that the ICU 205 does not contain a downlink diversity unit 108, which has been replaced by a power splitter 200, located within the ABDA 218. Accordingly, as previously explained, only the differences between the embodiments of FIGS. 2A and 2B are presented herein.

In particular, the downlink, signal transmitted by the BTS 101 is amplified by the controlled amplifier 109 and sent through a single cable, e.g., RF cable 113, to the ABDA 218. The downlink signal is split by the power splitter 200. The resulting branches are amplified by the LPAs 122 and 123 and sent to the cross-polarized antenna 132 via the cables 128 and 129 (through the duplexers 126 and 127), respectively. The polarization of the signal transmitted by the dual polarized antenna 132 is controlled by controlling the output power of the amplifiers 122 and 123 through the control card 107. An example of polarization control is included in PCT application Ser No. IB01/01028, filed on May 4, 2001, entitled “System and Method for Providing Polarization Matching on a Cellular Communication Forward Link,” the disclosure of which is expressly incorporated by reference herein in its entirety.

FIG. 2C is a block diagram depicting an exemplary ARFA unit 92 providing an RF extension of the BTS 101 with transmit polarization control that maximizes the utilization of the LPAs 122 and 123. The system in FIG. 2C is the same as the system in FIG. 2B, except that,the ABDA 318 does not include a power splitter 200, but does include hybrid circuits 202a, 202b, 203a and 203b, as well as phase shifters 138 and 140 in the BDA 120, and phase shifters 139 and 141 in the BDA 121. Therefore, only the differences between FIGS. 2B and 2C are discussed herein.

Each hybrid circuit comprises a passive 4-port circuit having specific coupling characteristics among the ports, as is known in the art. The hybrid circuits 203a and 203b, combined with the phase shifters 138 and 139, enable control over polarization of the transmitted signal. The phase shifters 138 and 139 serve as variable power dividers, while respectively keeping the LPAs 122 and 123 balanced, preferably at maximum power. For example, by feeding the downlink signal from line 113 into one input of the hybrid circuit 203a (the other input of the hybrid circuit 203a being terminated), both of the LPAs 122 and 123 receive half the signal, but shifted 90 degrees. By further shifting the phase of the downlink signal (e.g., through the phase shifters 138 and 139), the ratio of the power output by the hybrid circuit 203b to the duplexers 126 and 127 is controlled, without changing the levels of the LPAs 122 and 123.

Control over polarization of the received signal is similarly achieved by the hybrid circuit 202a and 202b and the phase shifters 140 and 141, which serve as a variable power coupler and divider, while keeping the LNAs 124 and 125 balanced at the preferred gain level. For example, when both inputs of hybrid circuit 202a are respectively fed from the duplexers 126 and 127 with the uplink signal, both LNAs 124 and 125 receive both signals, with a phase shift between them (e.g., 90 degrees). By adding additional phase shift to one of the uplink branches (e.g., through one of the phase shifters 140 and 141), the ratio of power output to the cables 115 and 116 by the hybrid circuit 202b is controlled without changing the levels of the LNAs 124 and 125.

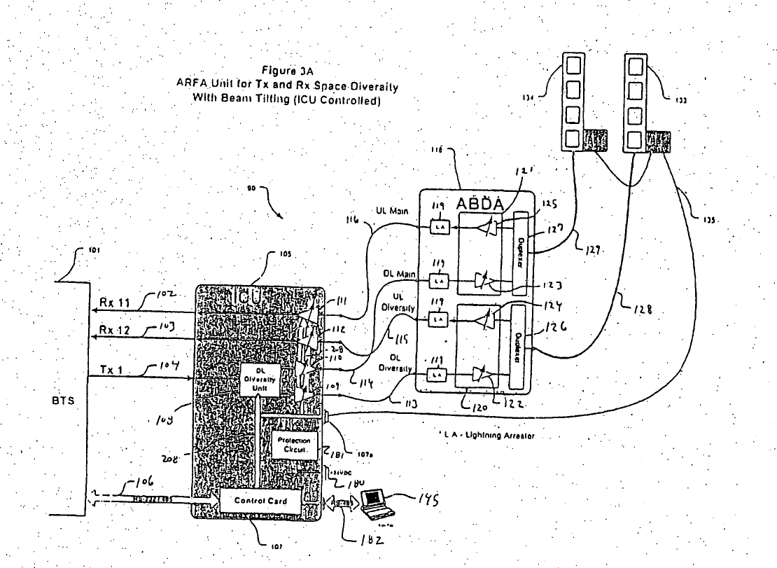

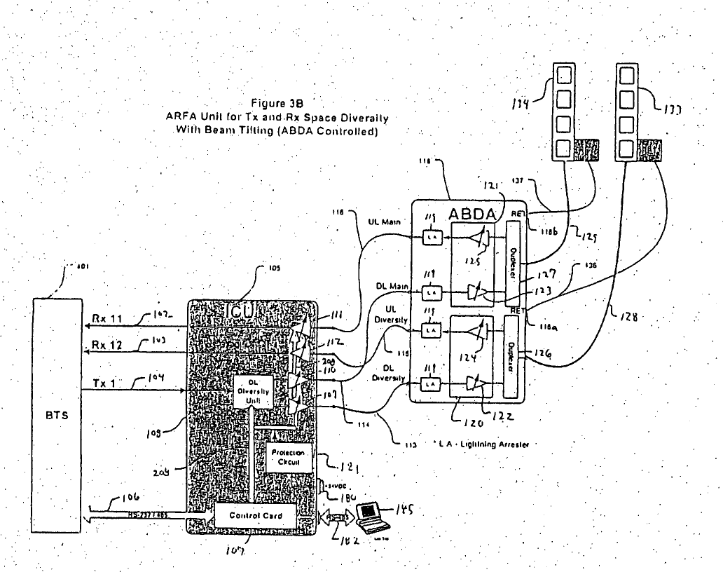

FIGS. 3A and 3B are block diagrams depicting exemplary ARFA units 90, each of which provides an RF extension of the BTS 101 with transmit and receive space diversity, including beam tilting. The systems shown in FIGS. 3A and 3B are the same as the system shown in FIG. 1, except that the antennas 133 and 134 comprise remote electrical tilt (RET) antennas, which are known in the art. Accordingly, as previously explained, only the differences between the embodiment of FIG. 1 and the embodiments of FIGS. 3A and 3B are presented herein.

Beam tilting generally redirects the elevation characteristics of an antenna pattern, by either physically repositioning the antenna and/or electrically altering the antenna pattern. The RET antennas 133 and 134 may be tilted, for example, using dielectric phase shifters driven by electric actuators and/or electric motors. The antennas 133 and 134 may be replaced by a dual polarization antenna, which provides remotely controlled electrical tilt, and the other elements depicted in FIG. 3A would remain the same.

In FIG. 3A, the tilt control for the RET antennas 133 and 134 is provided by a tilt control signal, provided at RET port 107a of the ICU 105 through a dedicated signal line 135. In comparison, FIG. 3B discloses an alternative embodiment, in which the tilt control of the RET antennas 133 and 134 is multiplexed with the diversity branch signal and the main branch signal and relayed from the ICU 105 over the RF cables 113-116 to the ABDA 118. The ABDA 118 communicates the tilt control signal through separate RET signal lines 136 and 137, connected to RET ports 118a and 118b, to the RET antennas 133 and 134, respectively. The embodiment depicted in FIG. 3B reduces the length of the control lines to the RET antennas 133 and 134, in that the control signals are initially sent from the ICU 105 over the existing cable connections with the ABDA 118.

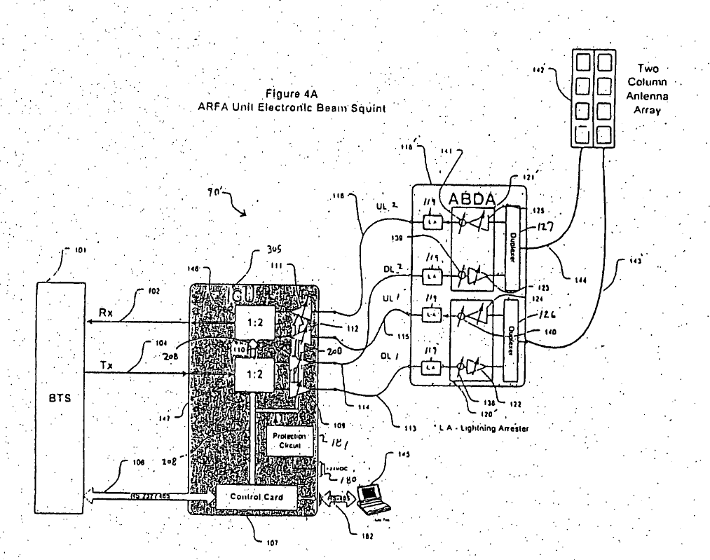

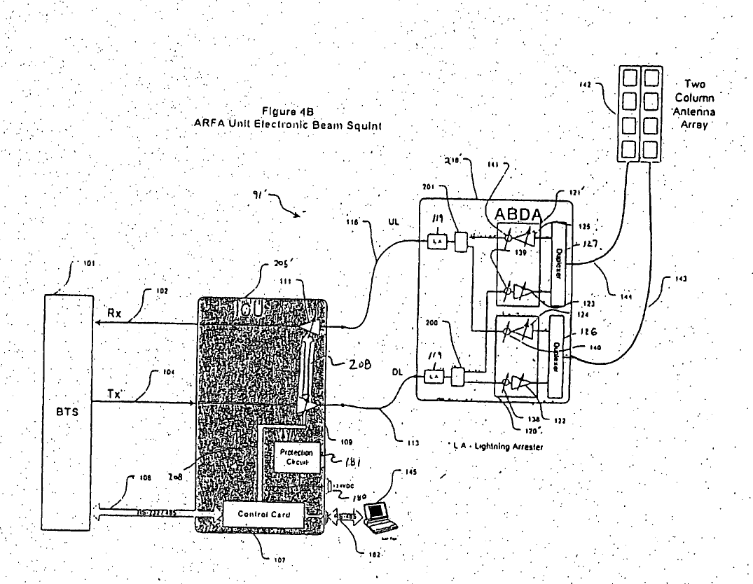

FIG. 4A is a block diagram depicting the exemplary ARFA unit 90′ providing an RF extension of the BTS 101, in which the RF extension electronically drives a steerable antenna, enabling beam squinting or steering of the antenna pattern. As in the previously described embodiments, to the extent that the system in FIG. 4A is the same as the system in FIG. 1, only the differences are presented herein. The transmission RF signal from the BTS 101 passes through the transmit RF cable 104 to the ICU 305, which includes power splitters 146 and 147, instead of a DL diversity unit 108. The ICU 305 splits the transmitted signal into two branch signals via the power splitter unit 147. As in FIG. 1, the first branch signal is amplified and conditioned in the amplifier 109 and the second branch signal is amplified and conditioned in the amplifier 110. The downlink branch signals are relayed by RF cables to the ABDA 118′ to the inputs of the respective BDAs 120 and 121′.

In addition to the transmission (downlink) LPA 122, the BDA 120′ includes an electronic phase shifter 138 at the input. The electronic phase shifter 138 is controllable by the control card 107, through either the control signaling interface 106 or 182. Likewise, the BDA 121′ includes an electronic phase shifter 139, operating in conjunction with the LPA 123. The phases of the downlink first branch signal and the downlink second branch signal are thereby controlled through the electronic phase shifters 138 and 139, respectively. The phase shifted branch signals are amplified by the LPAs 122 and 123 and relayed to different ports of the antenna 142 through the cables 143 and 144, respectively. The phase difference between the two branch signals generates a corresponding phase difference between the antenna ports.

In the depicted embodiment, the antenna 142 is a two column antenna array consisting of two antenna columns corresponding to the cables 143 and 144. The two antenna columns are typically spaced approximately one half of a transmission signal wavelength apart, for example. Each antenna column may include vertically arranged antenna elements that are coherently combined to form a beam, as known in the art. The exemplary antenna 142 therefore consists of two vertical columns of antenna elements, which coherently combine to form an antenna beam. The difference in the phase of the downlink branch signals feeding each column of antenna elements results in the beam, created by the joint radiation of the two columns, to steer according to the phase shift. In alternative embodiments, the two-column antenna 142 depicted in FIG.4A may be replaced by other phased antenna arrays generating steerable beam antennas, as is known in the art.

The uplink signal is received by the two columns of the antenna 142 and fed through the cables 143 and 144 to the respective first branch BDA 120′ and the second branch BDA 121′. The uplink signals pass through the LNAs 124 and 125, which amplify the received signal and compensate for cable losses that otherwise degrade the system noise figure. As in the downlink transmission, the LNAs 124 and 125 have corresponding digitally controlled phase shifters 140 and 141. The LNAs 124 and 125 therefore output phase-shifted branch signals. The phase difference between the first branch signal and the second branch signal is controlled by the control card 107 to create a receive antenna beam that coincides with the transmit antenna beam, generated as described above. However, in alternative embodiments, the phase difference may be controlled to create different transmit and receive antenna beams. For example, in one variation, each phase shift, and the resulting phase difference between the branch signals, is controlled based on pre-registered calibration of the phase shifters 138-141 for the different transmit and receive frequencies.

The amplified and phase-shifted receive branch signals are relayed via the cables 115 and 116 to the ICU 105, where they are amplified and equalized in the controlled amplifiers 112 and 111, respectively. The amplified branch signals are then combined in a combiner unit 146 and relayed to the BTS 101 through the RF cable 102.

FIG. 4B is a block diagram depicting the exemplary ARFA unit 91′, which is similar to the ARFA unit 91 of FIG. 2B, providing an RF extension of the BTS 101, in which the RF extension electronically drives a steerable antenna, enabling beam squinting or steering of the antenna pattern. As in the previously described embodiments, to the extent that the system in FIG. 4B is the same as the system in FIGS. 2B and 4A, only the differences are presented herein. The transmission RF signal from the BTS 101 passes through the transmit RF cable 104 to the ICU 205′, amplified and conditioned by the amplifier 109 and relayed to ABDA 218′ by RF cable 113. As in the embodiment of FIG. 2B, the power splitter 200 splits the transmitted signal into two branch signals. The first branch signal enters the BDA 120 and the second branch signal enters the BDA 121.

The BDA 120′ includes an electronic phase shifter 138 at the input. The electronic phase shifter 138 is controllable by the control card 107, through either the control signaling interface 106 or 182. Likewise, the BDA 121′ includes an electronic phase shifter 139, operating in conjunction with the LPA 123. The phases of the downlink first branch signal and the downlink second branch signal are thereby controlled through the electronic phase shifters 138 and 139, respectively. The phase shifted branch signals are amplified by the LPAs 122 and 123 and relayed to different ports of the antenna 142 through the cables 143 and 144, respectively. The phase difference between the two branch signals generates a corresponding phase difference between the antenna ports.

The uplink signal is received by the two columns of the antenna 142 and fed through the cables 143 and 144 to the respective first branch BDA 120′ and the second branch BDA 121′, as in FIG. 4A. The branches uplink signal are then amplified by LNAs 124 and 125, and phase shifted by the phase shifters 139 and 141, respectively, as in FIG 4A. The amplified and phase-shifted received branch signals are then combined within the ABDA 218′ by the signal combiner 201. The combined signal is relayed via the RF cable 116 to the ICU 205′, where it is amplified in the controlled amplifier 111. The amplified signal is then relayed to the BTS 101 through the RF cable 102.

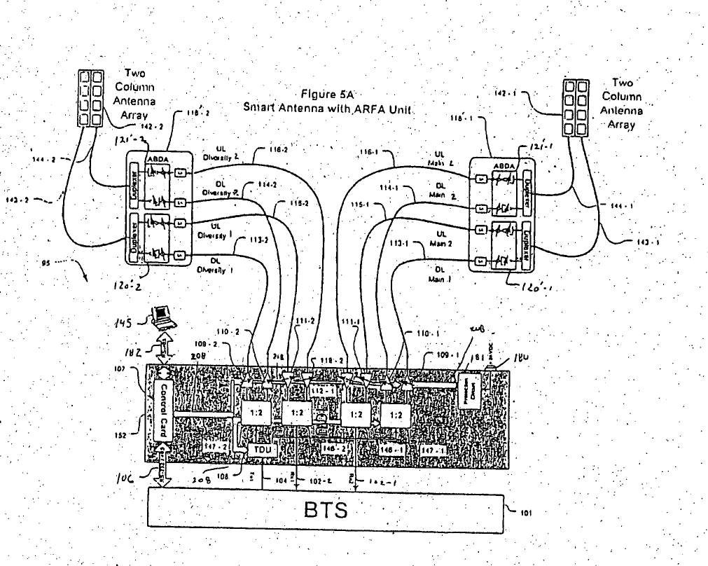

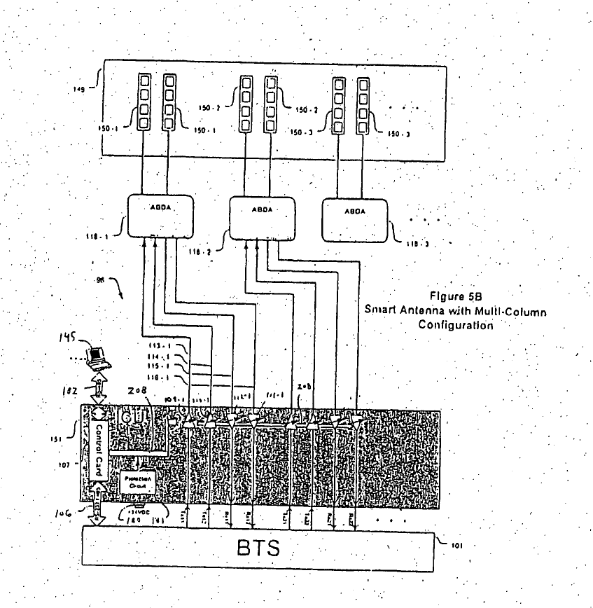

FIG. 5A is a block diagram depicting an exemplary ARFA unit 95 in a sector shaping RF access subsystem, such as a CELLSHAPER™, available from Celletra Ltd., monitored and controlled through the control card 107. An example of the CELLSHAPER™ is described in detail in PCT Application Ser. No. IB02/01525, filed on Jan. 29, 2002, entitled, “Antenna Arrangements for Flexible Coverage of a Sector in a Cellular Network,” the disclosure of which is expressly incorporated by reference herein in its entirety. The ARFA unit 95 is depicted in FIG. 5A as controlling a fully adaptive array antenna 142-1 and 142-2, referred to as a smart antenna. A smart antenna is a multi-beam array antenna that maybe controlled to form narrow beams that are matched to the disposition of the desired mobile station and the corresponding sources of signal interference.

The smart antenna of the sector-shaping RF access subsystem includes two electrically steered, two-column antennas 142-1 and 142-2, each of which may be identical to the antenna 142, described above with respect to FIGS. 4A and 4B. The antennas 142-1 and 142-2 are positioned in relation to one another to create an effective space diversity for both transmission and reception (e.g., typically approximately 10 transmission wavelengths apart). The antennas 142-1 and 142-2 are steered independently by the ABDA 118′. To enhance clarity of the disclosure, the ABDA 118′ is shown as being divided into two ABDAs (ABDA 118′-1 and ABDA 118′-2), which control the antennas 142-1 and 142-2, respectively. However, it is understood that the ABDA 118′ may be divided into any plurality of ABDAs without departing from the scope or spirit of the present invention. Likewise, it is noted that two of each element within the ABDA 118′ and the ICU 152 are depicted to enhance clarity, although it is understood that only one element is actually needed where there are duplicate element numbers. Transmit diversity is provided by the DL diversity unit 108 in the ICU 152, which is a modified version of the ICU 105 depicted in FIGS. 1.

Generally, when the antennas 142-1 and 142-2 are steered to the same direction, they jointly create a sector beam enhanced by transmit and receive space diversity. To widen the sector beam, the antennas 142-1 and 142-2 are steered to directions that differ from each other, for example, by approximately 60 degrees. The resulting sector beam spans both antenna beams, while the interference lobes typically generated between two similarly positioned antennas are eliminated by the de-correlation provided by the diversity modulation of the DL diversity unit 108. The functionality and characteristics of smart antennas are described in detail in PCT Application Ser. No. IB02/01525, filed on Jan. 29, 2002, entitled, “Antenna Arrangements for Flexible Coverage of a Sector in a Cellular Network,” discussed above.

The transmit signal coming from the BTS 101 through the cable 104 is fed to the DL diversity unit 108 in the ICU 152, which initially splits the transmit signal into two diverse branches. Each branch is further split by splitters 147-1 and 147-2 to provide two downlink main branch signals and two downlink diversity branch signals. The downlink main branch signals are fed into the amplifiers 109-1 and 110-1, while the downlink diversity branch signals are fed into the amplifiers 109-2 and 110-2, to provide a set of main branch signals and a set of diversity branch signals corresponding to each of the antennas 142-1 and 142-2, respectively. After amplification and conditioning, both sets of downlink signal branches are fed to the respective ABDAs 118′-1 and 118′-2 through the cables 113-1, 114-1, 113-2 and 1.14-2. The ABDA 118′-1 processes the two downlink main branches and the ABDA 118′-2 processes the two downlink diversity branches as described above with respect to FIG. 4A, including phase shifting the first branch and second branch signals of each set of transmitted downlink signals under the control of the control card 107. The ABDA 118′-1 feeds the first branch and second branches of the downlink main signal, with the controlled phase shift between them, to the antenna 142-1 through the cables 143-1 and 144-1, respectively. At the same time, the ABDA 118′-2 feeds the first and second branches of the downlink diversity signal, with the controlled phase shift between them, to the antenna 142-2 through the cables 143-2 and 144-2, respectively. The antennas 142-1 and 142-2 transmit the downlink signals in the consolidated sector beam, discussed above.

The main and diversity uplink signals received by the antennas 142-1 and 142-2 are fed to the respective ABDAs 118-1 and 118-2, each of which processes the uplink signal as described with respect to FIG. 4A. The first main branch output from ABDA 118′-1 is fed through cable 115-1 to the amplifier 111-1, and the second main branch output is fed through cable 116-1 to the amplifier 112-1 in the ICU 152. After controlled amplification and equalization, the first branch and second main branch signals are combined in the combiner 146-1. The combined main uplink signals are then relayed to the BTS 101 through the cable 102-1, as the main uplink branch. Similarly, the first diversity branch output from ABDA 118′-2 is fed through cable 115-2 to the amplifier 111-2, and the second diversity branch output is fed through cable 116-2 to the amplifier 112-2 in the ICU 152. After controlled amplification and equalization, the first and second diversity branch signals are combined in the combiner 146-2. The combined diversity uplink signals are then relayed to the BTS 101 through the cable 102-2, as the diversity uplink branch.

FIG. 5B is a block diagram depicting an exemplary ARFA unit 96 in a multi-column adaptive array RF access subsystem, monitored and controlled through the control card 107. Antenna array 149 includes multiple column arrays that are matched in pairs, including the depicted pairs of column arrays 150-1, 150-2 and 150-3. Typically, a multi-column adaptive antenna array includes two, four or eight column arrays, each being about half of one transmission wavelength apart from one another in a row. It is understood that any other even number of column arrays may be utilized without departing from the scope and the spirit of the present invention. Each pair of column arrays is linked to one ABDA 118′(e.g., ABDAs 118′-1, 118′-2 and 118-3). A set of four thin RF cables, cables 113-1, 114-1, 115-1 and 116-1, line the ABDA 118′-1 to the ICU 151, which is an enlarged ICU 105 encompassing multiple uplink and downlink preamplifiers. The other ABDAs are likewise linked by a corresponding set of RF cables (not shown) to the ICU 151. At the same time, the amplitude and/or phase of each downlink and uplink signal may be calibrated at the antenna ports as required for proper adaptive array control. The controls offered by the ARFA 96 allow for calibrating the transmission parameters, and for stabilizing them against variations with temperature and other environmental effects. The modularity offered by the ABDA 96 allows for easy installation, operation and maintenance.

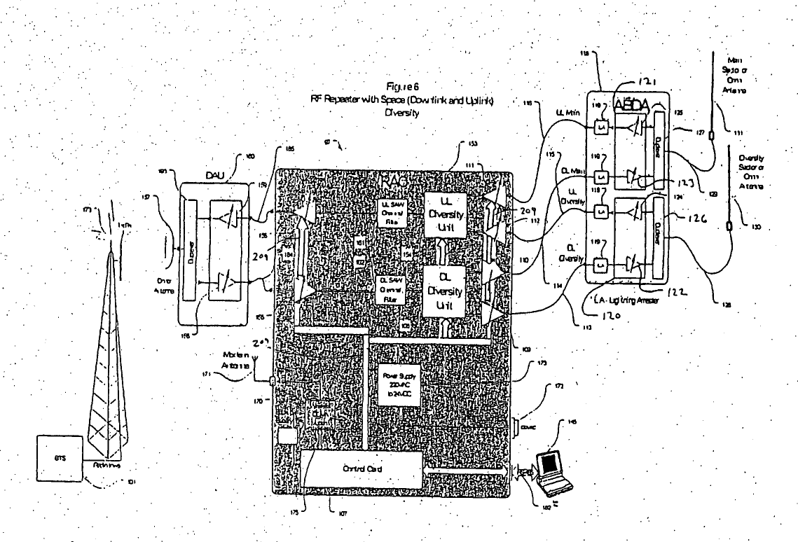

FIGS. 6 through 9 depict exemplary ARFA units that enhance the functionality of base stations in a cellular network by providing and/or enhancing RF repeaters associated with the base stations. FIG. 6, in particular, depicts an ARFA unit 97 in a RF repeater with transmit and receive diversity. The ARFA unit 97 includes a donor antenna unit (DAU). 160, a remote antenna controller (RAC) 153 and an ABDA 118. The RAC 153 is a modified ICU 105, which is ruggedized for outdoor operation and incorporates a wireless modem 170 for wireless remote control of the repeater through a modem antenna 171. The ABDA 118 is the same as the ABDA 118 depicted in FIG. 1, so the description of the ABDA 118 will not be repeated herein with respect to the RF repeater implementation of the present invention. The ABDA 118 is connected to the diversity antenna 130 and the main antenna 131, as in FIG. 1, through cables 128 and 129, respectively. The ARFA unit 97 is powered by, for example, a line voltage of approximately 220 volts AC, which is supplied to an AC power receptacle 172, which is converted to, for example, 24 volts DC by the power supply 173.

The ABDA 118 sends an uplink signal to the RAC 153 through the RF cables 115 and 116, respectively passing the diversity branch signal and the main branch signal. The branch signals are amplified and equalized by the amplifiers 111 and 112, and then modulated and summed in the uplink (UL) diversity unit 154, for example, in a manner similar to that described with respect to the DL diversity unit 108 in FIG. 1.

The combined uplink signal is then amplified by the controlled amplifier 156 and relayed to the DAU 160 through cable 185. The DAU 160 further amplifies the uplink signal via a controllable amplifier 159 and provides full-duplexing of the uplink signal via a duplexer 193. The amplifier 159 is controlled by the control card 107 of the RAC 153, through the control line 209, in the same manner as described with respect to the ABDA 118. In particular, the control signals are multiplexed with the RF signals and sent to the DAU 160 over an RF cable, such as the cable 184. The control line 209 is two directional, and is indicated by arrows between the control card 107 and the DL diversity units 108 and 154; the amplifiers 109, 110, 111 and 112; and the amplifiers 155 and 156. The uplink signal is transmitted through a donor antenna 157 to a receiving station (e.g., the donor base station, such as the BTS 101) at the transmit/receive antenna 173. The donor antenna 157 is a high gain, low power narrow beam antenna, such as a dish antenna, for example.

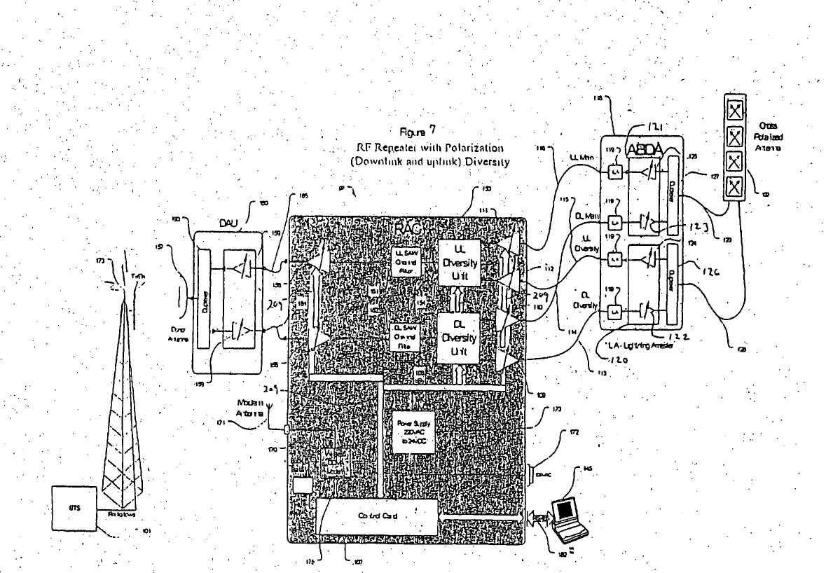

The extensive chain of amplifiers (e.g., 124, 125, 111, 112, 156 and 159) in the link are needed to maintain a high dynamic range over a range of gain states, while maintaining a low noise figure. Further, in the embodiments shown in FIGS. 6 and 7, an active channel filter 161; such as a surface acoustic wave (SAW) filter, is included to filter adjacent frequency band interference.

The downlink signal received by the donor antenna 157 (e.g., from the donor base station) passes through the duplexer 193 and is amplified by controlled amplifier 158 within the DAU 160. The amplified downlink signal is relayed through the cable 184 to the RAC 153, where it is amplified by controlled amplifier 155 (and optionally filtered by an active channel filter 162, e.g., a SAW filter). The DL diversity unit 108 splits and modulates the amplified (and optionally filtered) downlink signal into a diversity branch signal and a main branch signal, which are respectively amplified by the controlled amplifiers 109 and 110 and relayed to the ABDA 118 in the same manner described with respect to FIG. 1. Each of the controlled amplifiers are controlled through the control line 209. The downlink signals are transmitted to the mobile station, for example, through the diversity sector or omni antennas 130 and 131.

The modular configuration of the DAU 160, the RAC 153 and the ABDA 118 enables maximum flexibility in setting the repeater parameters for optimal operation, while providing transmit and receive diversity. The repeater parameters are set by the control card 107, which communicates with the BTS 101 through the RS-232 interface 175, the wireless CDMA modem 170 and the modem antenna 171. Alternatively, the repeater parameters may be set by the monitoring and control device 145 (e.g., a laptop computer) through the RS-485 interface 182. A modular installation mitigates the loss in the cables to both the distribution antenna (e.g., the antennas 130 and 131) and the donor antennas and reduces the noise figure of the repeater. It is also advantageous where the repeater elements must be separated by a significant distance due to geographic, structural or other installation constraints.

FIG. 7 depicts an ARFA unit 97 configured as an RF repeater with transmit and receive diversity. In FIG. 7, the antenna 132 comprises a dual polarization antenna, such as a cross-polarized antenna, for example, as opposed to the space diverse antennas 130 and 131 shown in FIG. 6. Otherwise, the structure of FIG. 7 is the same as the structure of FIG. 6. The description of the operations of the invention uising a cross-polarized antenna 132 provided with respect to FIG. 2 is applicable to the repeater embodiment of FIG. 7, and therefore will not be repeated herein. Further, it is understood that alternative embodiments of the present invention implemented as RF repeaters may incorporate any other type of antenna compatible with implementing the invention as an RF extension of the BTS 101, as shown in FIGS. 3A-5B. For example, RET antennas may be accommodated in an RF repeater having the ARFA unit 97, as disclosed in FIGS. 3A and 3B.

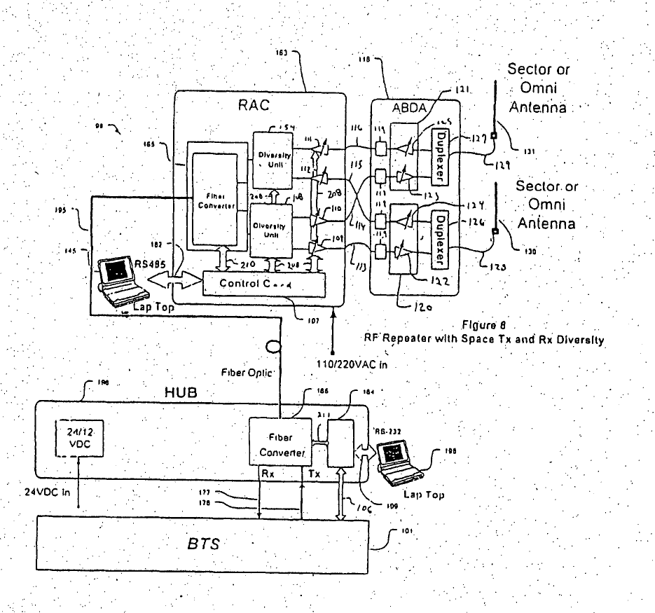

FIG. 8 depicts an ARFA unit 98 in a fiber-linked repeater with transmit and receive diversity. The use of fiber optic lines greatly reduces line losses incurred while communicating signals to and from a base station, such as the BTS 101. In the embodiment of FIG. 8, the ARFA unit 98 includes a hub 196, a RAC 163, and an ABDA 118, which control the space diversity antennas 130 and 131. The ABDA 118 and the antennas 130 and 131 are the same as shown in FIGS. 1 and 6, so the description of these elements will not be repeated with respect to FIG. 8.

The RAC 163 is the same as the RAC 153 depicted in FIG. 6, except that the RAC 163 is modified to incorporate a fiber converter 165. The fiber converter 165 converts RF signals received by the repeater (i.e., the uplink signals) to a wavelength compatible with transmission over a fiber optic line 195, and transmits the converted signal over the fiber optic line 195 to the hub 196, in a known manner. For example, the uplink signals may be amplitude modulated into an optical signal by a laser diode in the fiber converter 165. The hub 196 includes a matching fiber converter 166, which converts (e.g., demodulates) the received signal back to an RF signal. The hub 196 sends the RF signal to the donor base station (e.g., the BTS 101) through the RF cable 177. In a variation of the disclosed embodiment, the hub 196 may amplify the RF signals through controllable amplifiers (not shown), such as the amplifiers 111 and 112, discussed with respect to the embodiment shown in FIG. 1, prior to sending the RF signals to the BTS 101. The amplifiers may be controllable, for example, by a control circuit 164 through either the monitoring and control device 198 (e.g., a laptop computer) via a control interface 199, or the BTS 101 via the control interface 106. In an embodiment of the invention, the monitoring and control device 198 may be the same, computer as the monitoring and control device 145. The control interface 199 may be any compatible serial interface, such as RS-232 or RS-485.

With respect to transmitting an RF signal (i.e., the downlink signal), the donor base station BTS 101 sends an RF signal to the hub 196 over cable 178. The fiber converter 166 converts the signal to a wavelength compatible with transmission over the fiber optic line 195, and transmits the converted signal over the fiber optic line 195 to the matching fiber converter 165 of the RAC 163. The fiber converter 165 converts the transmitted signal back to an RF signal, and sends the RF signal through the remaining elements of the RAC 163, as described with respect to RAC 153 in FIG. 6, above. The RAC 163 sends the diversity branch signal and the main branch signal to the ABDA 118, which feeds the antennas 130 and 131, respectively, for transmission of the downlink signal. The construction and operation of the fiber converters 165 and 166 are known in the art, and thus are not described in detail herein.

The fiber converter 165 is environmentally sensitive, and the RAC 163 provides both environmental protection and control over the parameters for remote calibration. For example, the fiber converter 165 may be monitored and controlled, along with other elements of the ARFA unit 98, by the control card 107 through the RS-485 interface 182 and the monitoring and control device 145 (e.g., a laptop computer). The control signals are communicated between the fiber converter 165 and the control card 107 via a control line 210. The fiber converter 166 may be monitored and controlled by the control circuit 164, through a serial interface such as, but not limited, to the control interface 199 and the monitoring and control device 198 or the control interface 106 and the BTS 101. The control signals are communicated between the fiber converter 166 and the control circuit 164 via a control line 211.

In an alternative embodiment, the fiber converters 165 and 166 may be controlled through a shared control circuit, such as the control circuit 164, by multiplexing the control signals with the RF signals, prior to converting the RF signals to an optical signal, and sending the control signals to the RAC 163 via the fiber optic line 195. Alternatively, the control card 107 and the BTS 101 may communicate control data through a modem connection (not shown), such as the wireless CDMA modem 170 and the modem antenna 171, shown in FIGS. 6 and 7.

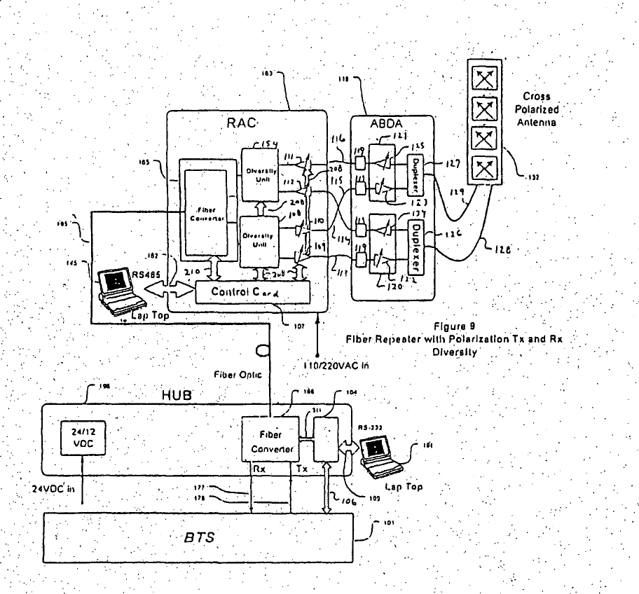

FIG. 9 depicts an ARFA unit 98 in a fiber-linked repeater with transmit and receive diversity. FIG. 9 differs from FIG. 8 only in that the antenna 132 includes a dual polarization antenna, such as, but not limited to, a cross-polarized antenna, as opposed to a the space diverse antennas 130 and 131 shown in FIG. 8. The description of the invention using a cross-polarized antenna, which was provided with respect to FIG. 2, is applicable to the fiber-linked repeater embodiment, and therefore will not be repeated herein. Similarly, it is understood that alternative embodiments of the present invention implemented with fiber-linked RF repeaters may incorporate any other type of antenna compatible with implementing the invention as an RF extension of the BTS 101, as shown in FIGS. 3A-5B. For example, an RET antenna may be accommodated in a fiber-linked RF repeater having an ARFA unit 98, as disclosed in FIGS. 3A and 3B.

According to the invention described herein, the functionality of a base station in a cellular network, for example, is enhanced by an ARFA unit comprising either a controllable modular RF front-end or a controllable modular RF repeater. The ARFA unit is capable of duplex communications with receivers, such as mobile units, so the downlink and uplink signals are transmitted and received at the same antenna system. The AFRA unit, which is separate and distinct from the base station and the antenna system, is interchangeable among new and/or existing base stations, as well as any type of antenna system. The invention therefore enables enhancement of existing network systems without significant reconfiguration or replacement of those systems.

Although the invention has been described with reference to several exemplary embodiments, it is understood that the words that have been used are words of description and illustration, rather than words of limitation. Changes may be made within the purview of the appended claims, as presently stated and as amended, without departing from the scope or spirit of the invention in its aspects. Although the invention has been described with reference to particular means, materials and embodiments, the invention is not intended to be limited to the particulars disclosed; rather, the invention extends to all functionally equivalent structures, methods and uses such as are within the scope of the appended claims.

It should be noted that the software implementations of the present invention as described herein are optionally stored on a tangible storage medium, such as: a magnetic medium such as a disk or tape; a magneto-optical or optical medium such as a disk; or a solid state medium such as a memory card or other package that houses one or more read-only (non-volatile) memories, random access memories, or other re-writable (volatile) memories. A digital file attachment to e-mail or other self-contained information archive or set of archives is considered a distribution medium equivalent to a tangible storage medium. Accordingly, the invention is considered to include a tangible storage medium or distribution medium, as listed herein and including art-recognized equivalents and successor media, in which the software implementations herein are stored.

Although the present specification describes components and functions implemented in the embodiments with reference to particular standards and protocols (e.g., RS-232, RS-485, USB, IEEE 1394), the invention is not limited to such standards and protocols. Likewise, each of the standards for wireless or telephonic communications (e.g., CDMA, CDMA2000, UMTS, GSM, PCS, IS-95) represent examples of the state of the art. Such standards are periodically superseded by faster or more efficient equivalents having essentially the same functions. Accordingly, replacement standards and protocols having the same functions are considered equivalents.

1. A modular front-end system of a base station in a wireless communications network, that is interoperable with different antenna types, the front-end system comprising:
at least one controllable bi-directional amplifier, located remotely from the base station, at least one parameter of the bi-directional amplifier being controlled through a control circuit in the front-end system; and
at least one duplexer that interfaces the at least one bi-directional amplifier to an antenna, enabling simultaneous transmission and reception through the antenna.

2. The modular front-end system of a base station according to claim 1, wherein the control circuit receives control signals from at least one of the base station, via a first control interface, and a remote monitoring and control device, via a second control interface.

3. The modular front-end system of a base station according to claim 2, wherein each of the first control interface and the second control interfaces comprises a serial interface.

4. The modular front-end system of a base station according to claim 1, wherein the at least one parameter of the bi-directional amplifier comprises a signal gain.

5. The modular front-end system of a base station according to claim 1, wherein the at least one parameter of the bi-directional amplifier comprises a signal phase.

6. The modular front-end system of a base station according to claim 1, wherein the antenna is located remotely from the at least one bi-directional amplifier.

7. The modular front-end system of a base station according to claim 6, wherein the antenna comprises one of a sector antenna and an omni antenna.

8. The modular front-end system of a base station according to claim 6, wherein the antenna comprises a diversity antenna system.

9. The modular front-end system of a base station according to claim 8, wherein the diversity antenna system comprises at least two antennas spaced for space diversity.

10. The modular front-end system of a base station according to claim 8, wherein the diversity antenna system comprises a dual polarization antenna.

11. The modular front-end system of a base station according to claim 10, wherein the dual polarization antenna comprises a plurality of beams, each beam being electrically controlled to tilt by the control circuit.

12. The modular front-end system of a base station according to claim 8, wherein the diversity antenna system comprises a multiple column array antenna.

13. The modular front-end system of a base station according to claim 1, wherein at least one of the base station and the antenna comprise an existing base station system, and the bi-directional amplifier and the duplexer are adapted to interface with the existing base station system.

14. A method for enhancing transmission and reception of signals at a base station in a wireless communications network, using a full-duplex modular radio frequency (RF) front-end, which is interoperable with different base station antenna systems, the method comprising:
receiving a transmit signal, at the modular RF front-end, from the base station;
splitting the transmit signal into a transmit diversity branch and a transmit main branch;
processing at least one of the transmit diversity branch and the transmit main branch in accordance with a remotely issued control signal; and
after processing, sending the transmit diversity branch and the transmit main branch to a predetermined base station antenna system for transmission at a selected RF frequency.

15. The method for enhancing transmission and reception of signals at a base station according to claim 14, further comprising:
receiving a receive diversity branch and a receive main branch of a received signal from the predetermined antenna system;
processing at least one of the receive diversity branch and the receive main branch in accordance with a second remotely issued control signal; and
after processing, sending the receive diversity branch and the receive main branch to the base station for detection.

16. The method for enhancing transmission and reception of signals at a base station according to claim 14, further comprising:
shifting a phase of the transmit diversity branch with respect to the transmit main branch in accordance with the remotely issued control signal.

17. The method for enhancing transmission and reception of signals at a base station according to claim 14, wherein the remotely issued control signal is issued by a remote monitoring and control terminal through a serial interface.

18. The method for enhancing transmission and reception of signals at a base station according to claim 17, the serial interface comprising an RS-485 interface.

19. The method for enhancing transmission and reception of signals at a base station according to claim 14, the processing comprising amplifying the transmit diversity branch and the transmit main branch in accordance with the control signal.

20. The method for enhancing transmission and reception of signals at a base station according to claim 15, the processing comprising amplifying the receive diversity branch and the receive main branch in accordance with the second control signal.

21. A repeater system, associated with a base station in a wireless communications network, that is interoperable with different antenna types, the repeater system comprising:
at least one controllable bi-directional amplifier, at least one parameter of the bi-directional amplifier being remotely controlled through a control circuit in a remote repeater controller.
at least one duplexer that interfaces the at least one bi-directional amplifier to an antenna, enabling simultaneous transmission and reception of radio frequency (RF) signals through the antenna; and
a donor interface that enables communication with the base station.

22. The repeater system according to claim 21, wherein the control circuit receives control signals from at least one of the base station, via a wireless modem and a first control interface, or a remote monitoring and control device, via a second control interface.

23. The repeater system according to claim 21, wherein the antenna comprises one of a sector antenna and an omni antenna.

24. The repeater system according to claim 21, wherein the antenna comprises a diversity antenna system.

25. The repeater system according to claim 24, wherein the diversity antenna system comprises at least two antennas spaced for space diversity.

26. The repeater system according to claim 24, wherein the diversity antenna system comprises a dual polarization antenna.

27. The repeater system according to claim 26, wherein the dual polarization antenna comprises a plurality of beams, each beam being electrically controlled to tilt by the remote repeater controller.

28. The repeater system according to claim 24, wherein the diversity antenna system comprises a multiple column array antenna.

29. The repeater system according to claim 21, wherein at least one of the base station and the antenna comprise an existing base station system, and the bi-directional amplifier and the duplexer are adapted to interface with the existing base station system.

30. The repeater system according to claim 21, wherein the donor interface comprises a donor antenna unit that communicates the RF signals with the base station through a donor antenna.

31. The repeater, system according to claim 21, wherein the donor interface comprises a plurality of fiber converters that convert between the RF signals and a wavelength compatible with transmission over a fiber optic line, a first fiber converter being located on a first end of a fiber optic line, associated with the base station, and a second fiber converter being located on a second end of the fiber optic line, associated with the repeater system.

32. A method for enhancing transmission and reception of signals at a base station in a wireless communications network, using a full-duplex modular radio frequency (RF) repeater, which is interoperable with different antenna systems, the method comprising:
receiving a transmit signal, at the modular RF repeater, from the base station through a donor communications link;
splitting the transmit signal into a transmit diversity branch and a transmit main branch;
processing at least one of the transmit diversity branch and the transmit main branch in accordance with a remotely issued control signal; and
after processing, sending the transmit diversity branch and the transmit main branch to a repeater antenna system for transmission.

33. The method for enhancing transmission and reception of signals at a base station according to claim 32; further comprising:
receiving a receive diversity branch and a receive main branch of a received signal frequency from the repeater antenna system;
processing at least one of the receive diversity branch and the receive main branch in accordance with a second remotely issued control signal; and
after processing, sending the receive diversity branch and the receive main branch through the donor communications link to the base station for detection.

34. The method for enhancing transmission and reception of signals at a base station according to claim 32, wherein the donor communications link comprises a narrow beam antenna.

35. The method for enhancing transmission and reception of signals at a base station according to claim 32, wherein the donor communications link comprises a fiber optic line.

36. A modular system for enhancing a base station comprising:
a plurality of controllable bi-directional amplifiers;
a plurality of duplexers, each duplexer interfacing the plurality of controllable bi-directional amplifiers with a respective one of a plurality of antenna elements to enable simultaneous transmission and reception; and
a control circuit, located remotely from the plurality of bi-directional amplifiers, that enables control of at least one parameter in each of the plurality of bi-directional amplifiers to control at least one transmission and reception characteristic.

37. The modular base station enhancing system according to claim 36, wherein each of the plurality of controllable bi-directional amplifiers comprises at least a linear power amplifier that amplifies transmitted signals, and a low-noise amplifier that amplifies received signals.

38. The modular base station enhancing system according to claim 36, wherein the plurality of bi-direction amplifiers and the plurality of duplexers are located in one of a front-end extension of the base station or a repeater associated with the base station.

39. The modular base station enhancing system according to claim 36, wherein the modular system interfaces an existing base station and an existing plurality of antenna elements.

40. The modular base station enhancing system according to claim 36, further comprising at least one modem, wherein the control circuit enables control of the at least one parameter in the plurality of bi-directional amplifiers via the at least one modem.
